(19) United States
(12) Patent Application Publication
(10) Pub. No.: US 2007/0204222 A1
(43) Pub. Date: Aug. 30, 2007

(54) Method and Apparatus for Rendering Content on a Browser

(76) Inventors: Andrew Timothy Rogan, Saratoga, CA (US); Akshar Kharebov, Goleta, CA (US); Sergey Lossev, Goleta, CA (US); Sean Garret Fannan, South Lake Tahoe, CA (US)

Correspondence Address: Hahn and Moodley LLP, P.O. Box 52050, Minneapolis, MN, 55402, US

(21) Appl. No.: 11/613,942

(22) Filed: Dec. 20, 2006

Related U.S. Application Data
(60) Provisional application No. 60/752,654, filed on Dec. 20, 2005.

(51) Int. Cl. G06F 17/00

(52) U.S. Cl. 715/539; 715/530; 715/513; 715/521

(57) ABSTRACT

In one embodiment, the invention provides a method, comprising: receiving user-defined settings to control the rendering of content by a browser; receiving content from a web-server, the content defining a web-page; receiving default settings from the web-server to control how the content is to be rendered by the browser; and rendering the content in the browser in accordance with the user-defined settings.

This application claims the benefit of priority to U.S. Provisional Patent Application No. 60/752,654 which was filed on Dec. 20, 2005 and is entitled METHOD AND APPARATUS FOR RENDERING CONTENT ON A BROWSER.

### FIELD

Embodiments of the invention relate to the rendering of content on a browser.

### BACKGROUND

Today, computers may be equipped with software to enable a user to view content that is typically downloaded over a network such as the Internet. The software is known as a “web-browser” or “browser” and the content may include images text, graphics, etc. The content may be downloaded from a web server and may be associated with a website hosted by the web server at a particular web address or Uniform Resource Locator (URL). In this case, the content associated with the website is rendered by the browser on a display device or a host computer in accordance with the preferences/design constraints set by the developer of a website. For example, the developer may specify that the content that is to be bound or associated with particular content areas are on a browser. Further, the content may be rendered in accordance with display parameters set by the developer.

### BRIEF DESCRIPTION OF THE DRAWINGS

FIG. 1 shows a network environment within which embodiments of the invention may be practiced;

FIG. 2 shows a high-level block diagram a client device, in accordance with one embodiment of the invention;

FIG. 3 shows flowcharts of the processes involved in setting user parameters in accordance with one embodiment of the invention;

FIGS. 4 and 5 show how content may be rendered in accordance with user-defined settings/parameters, in accordance with different embodiments of the invention; and

FIG. 6 shows a high level block diagram of hardware that may be used to implement a client system or a server associated with user-defined settings/parameters in accordance with one embodiment of the invention.

### DETAILED DESCRIPTION

In the following description, for purposes of explanation, numerous specific details are set forth in order to provide a thorough understanding of the invention. It will be apparent however, to one skilled in the art that the invention can be practiced without these specific details. In other instances, structures and devices are shown in block diagram form only in order to avoid obscuring the invention.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Embodiments of the invention relate to how web content is displayed on a browser. The appearance of web content is generally controlled by a web site developer. Thus, for example, a web-site developer may specify that content is spatially bound to areas of the browser, which for purposes of this specification will be referred to as “content areas,” or “areas.” As such, these bindings are static, and are not user adjustable. For example, if the web developer binds content such as local weather information to the top left hand corner of the browser, the content will always be bound to that area and a user has no way to change how that content is displayed on a device. Embodiments of the invention disclose techniques which allow a user to specify preferences which override pre-existing settings that control how content is rendered on a browser. An advantage is that a user can customize the display of content on the browser.

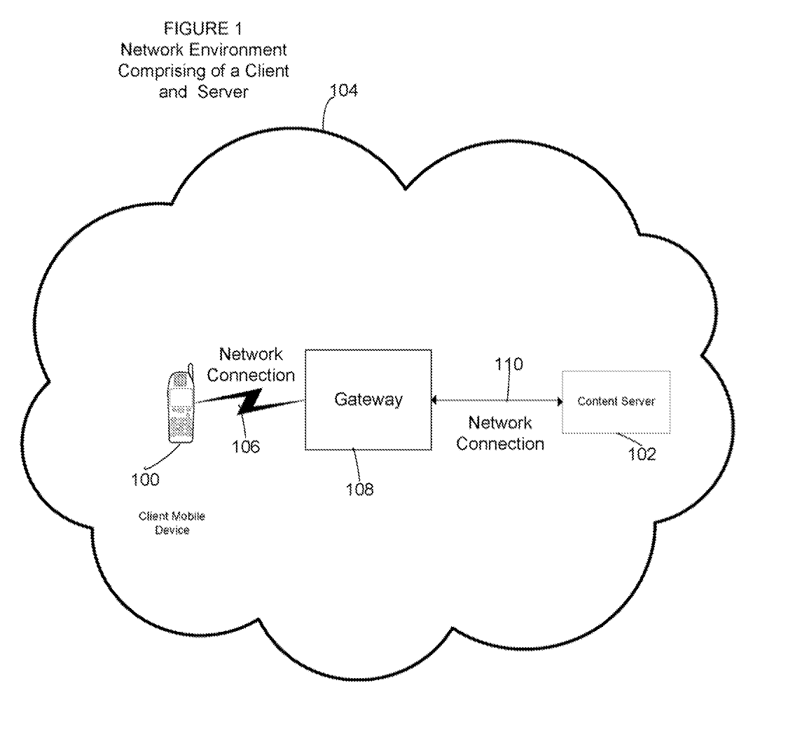

FIG. 1 of the drawings shows a high-level block diagram of a network environment 104 within which embodiments of the invention may be practiced. The network environment 104 includes a client mobile device 100 and a server 102. The client mobile device 100 and server 104 are coupled via a gateway 108. As used herein, the term “client” includes any device which can transmit and/or receive data and display it graphically. Examples of a client include a terminal computer, a personal digital assistant, a mobile phone, etc. The mobile client device 100 requests, receives, and displays content. As used herein, the term “server” includes any device such as a computer which can send, receive and process data over a network. The content may be stored on the server 102 or obtained from other sources. As used herein, the term “gateway” includes any type of device which sends and receives data between devices. Examples of a gateway include routers and switches.

The client mobile device 100 and server 102 communicate through the network 104 via network connections, 106 and 110 The network connections 106, 110 include any type of connection, whether physical or nonphysical, that allows for the transmission and reception of information. Examples of the network connection 106, 110 include an Ethernet connection and a connection in accordance with the 802.11 wireless communications standard.

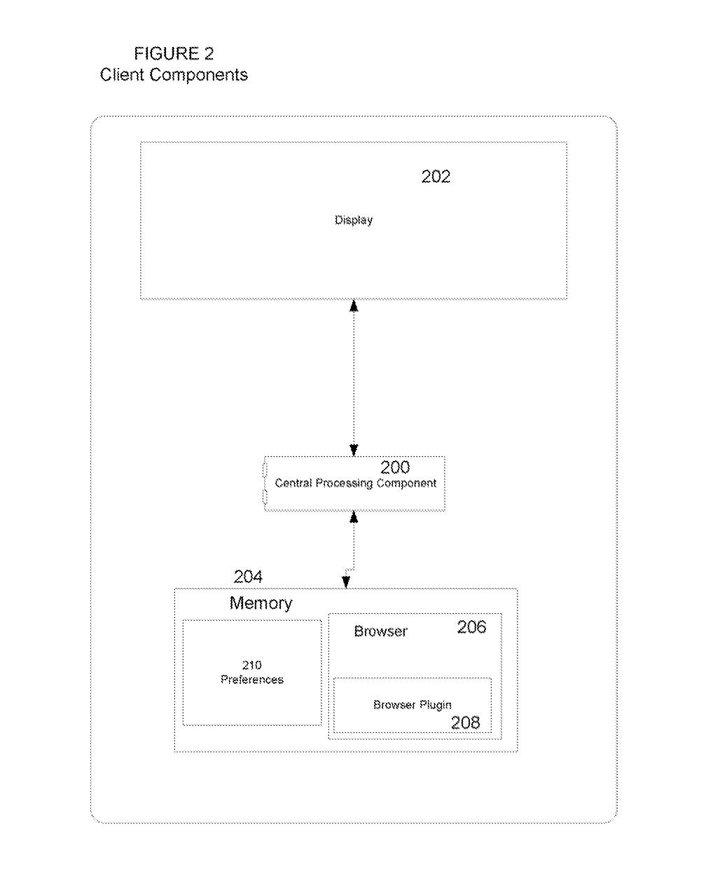

FIG. 2 of the drawings show a high-level block diagram of the client mobile device 100, in accordance with one embodiment. The client 100 comprises a central processing component 200 coupled to a display 202, and a memory 204. The memory 204 includes a browser 206 which is capable of receiving and rendering content. The browser 206 contains a plug-in 208 which controls how the browser 206 will display content. As user herein, the term “plug-in” includes any component which interacts with a browser. The browser plug-in 208 controls the rendering of content based upon user-defined preferences 210.

The preferences 210 may be stored in the memory 214. It is to be appreciated that the client device includes many other components that have been omitted so as to prevent the invention from being obscured.

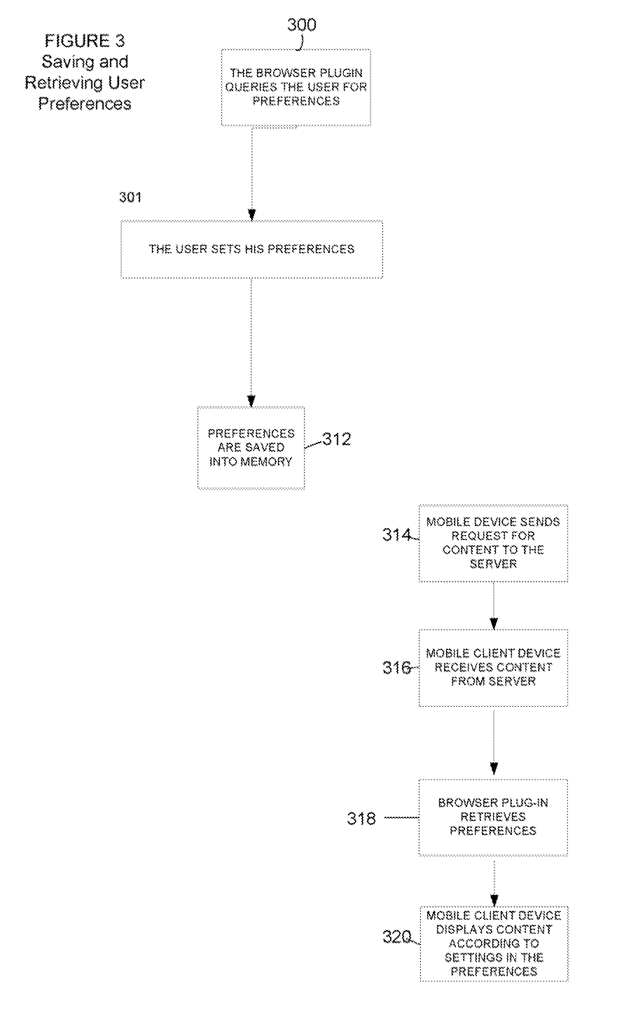

FIG. 3 of the drawings show flowcharts of operations performed by the plug-in 208, in accordance with one embodiment of the invention. Referring to FIG. 3, at block 300 the client queries the user for his/her preferences 210 on how content should be rendered. At block 301 the user sets his/her preferences on how content is to be rendered. In general, the preferences 210 include settings that control the appearance of content. Content is subsequently rendered in content areas of the browser 206 according to these settings. Examples of these settings in accordance with one embodiment are shown in Table 1.

TABLE 1
User-Defined Settings

| Setting | Effect |
|---|---|
| Content Hide | Controls whether to show or not show a content area. |
| Content | Controls how content areas overlap one another. |
| Overlap | |
| Background | Controls whether a default background for a content area |
| Override | is to be replaced with a custom background. |
| Content | Controls the shape of a content area. |
| Area Shape | |
| Content Mix | Content setting that causes content for one area to be |
| | mixed with content from another area. |

As will be seen, the user-defined settings include a “content hide” setting that controls whether to show or not show an area, a “content overlap” setting that controls whether content areas overlap each other, a “background override” setting that controls whether a default background for a content area is to be replaced, a “content area shape” setting that controls a shape of a content area, and a “content mix” setting that causes content for one area to be mixed with content from another area. The specific behavior that these settings invoke will be described later. After the user has set his/her settings 210, the plug-in 208 then stores the preferences 210 in the memory 204 at block 312, for subsequent retrieval. The settings of Table 1 are merely illustrative of the settings that control appearance, in one embodiment. Thus, other settings that control the appearance of the content areas are within the scope of the invention.

At block 314 the mobile client device 100 requests content from the server 102. At block 316 the mobile client device 100 receives the content from the server 102. At block 318 the plug-in 208 retrieves user-defined preferences 210 from the memory 204. The plug-in 208 then determines if any user-defined settings are stored in the memory 204. If there are no user-defined settings for the content then the content is displayed on the browser 206 without overriding the default settings set by the web-developer. Otherwise the user-defined settings are used to override any pre-existing settings defined by the web developer. At block 320 the browser 206 renders the content in accordance with the user-defined settings instead of in accordance with the pre-existing settings defined by the web developer.

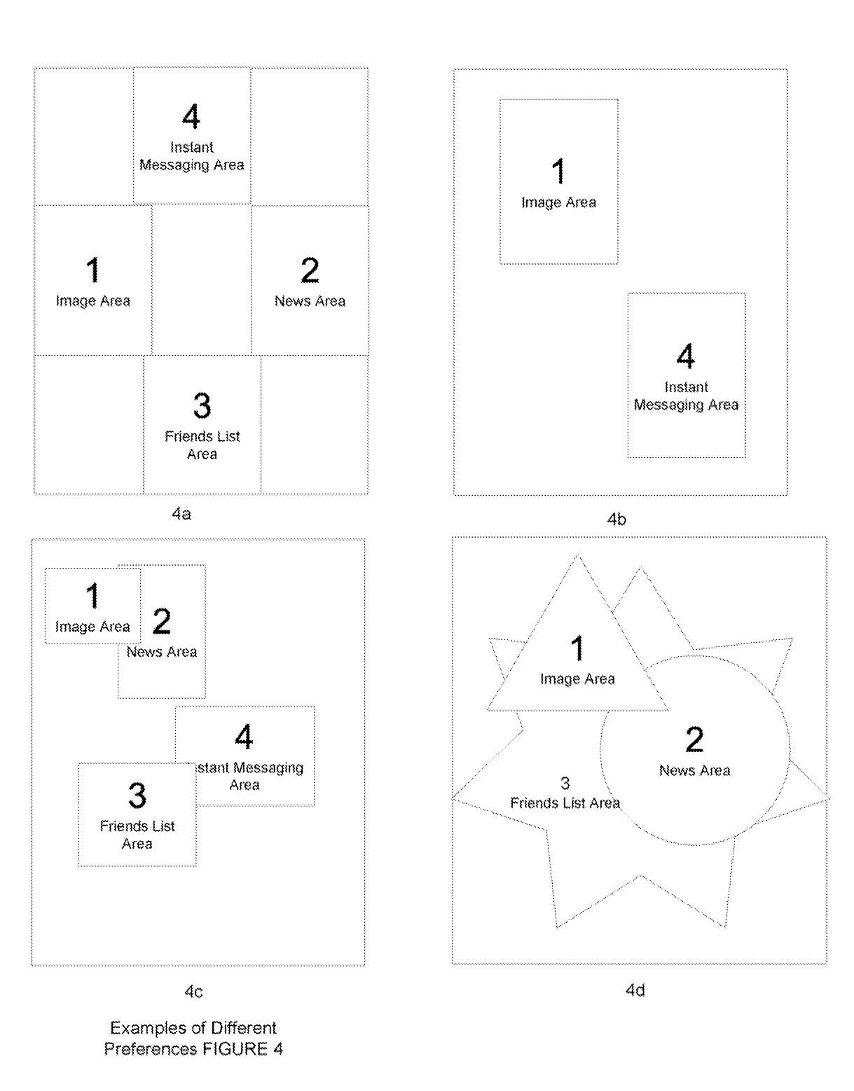

FIG. 4a through FIG. 4d of the drawings show example diagrams of how content is rendered by the browser 206 on the display 202, in accordance with one embodiment of the invention. FIG. 4a shows how information is displayed in accordance with settings defined by a web developer. Here the plug-in 208 has been disabled and content is bound to static content areas represented by the content areas numbered 1 through 4. In this example area 1 represents an image area, area 2 a news area, area 3 a friends list area, and area 4 an instant messaging area. The four content areas contain different types of content. These content areas have their positions predetermined by the web developer and cannot be changed by the user.

In contrast, FIG. 4b of the drawings show how the “content hide” setting may be used to control the appearance of content. Here, the user has set the “content hide” setting in respect to areas 2 and 3. As a result, the plug-in 208 overrides the default settings and areas 2 and 3 are not rendered by the browser. Only content areas 1 and 4 are rendered. The “content hide” setting can thus be used to control what content a user wishes to see.

In FIG. 4c another exam pie of how the user can control the display of content through the plug-in 208 is shown. Here, the “content overlap” setting has been set. The “content overlap” setting controls how content areas overlap one another. In this case, the user has set area 1 to overlap with area 2, and area 3 to overlap with area 4. Thus, the image area 1 overlaps the news area 2 and the friends list area 3 overlaps instant messaging area 4.

FIG. 4d shows the effect of having multiple user-defined settings overriding the default settings. The “content hide” setting has been set for area 4, and the “content overlap” setting has been set for areas 1, 2, and 3. In addition, the “content area shape” setting has been set for areas 1, 2 and 3. As a result, the plug-in 208 overrides the default settings and the browser 206 overlaps content areas 1, 2 and 3. Note that the shapes for areas 1, 2, and 3 have changed. This is due to the “content area shape” setting that specifies the shape of an area. Using the “content area shape” setting a content area may be rendered in any arbitrary shape. In FIG. 4d, the area 4 has been omitted due to the “content hide” setting being set.

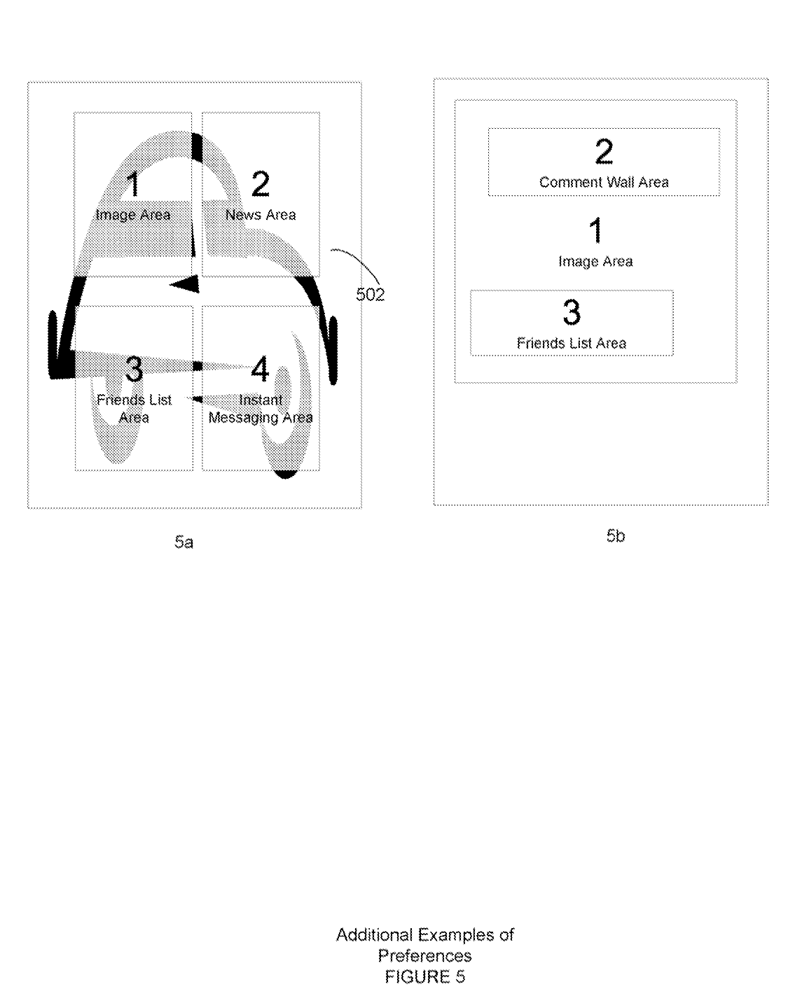

FIG. 5 of the drawings show additional example drawings of how content is rendered in accordance to one embodiment of the invention. In FIG. 5a the “background override” setting is set for areas 1 through 4. As a result, the content areas 1 through 4 are displayed with a background 502. The background 502 is user customizable. The “background override” setting may be set for each content area. Thus, each content area may have its own background set by a user. In one embodiment, when setting the “background override” setting for a particular content area, the user may save a background for the content area at a particular memory location. The browser 206 retrieves the background from the memory location and displays the background in the content area.

FIG. 5b shows how content from content areas can be mixed or rendered together. Here content areas 2 and 3 are mixed because the “content mix” setting is set. In the FIG. 5b the image area 1 may contain photographs and the comments area 2 may contain comments about the photographs being displayed in image area 1. Additionally, content from a friends list area 3 containing friends who share the same photographs as displayed in area 1 may be mixed with the content from area 1. Since the comments may be regarding particular images from image area 1, the “content mix” setting may be set to cause the content from area 2 to be mixed with the content from area 1. The effect is that the comments regarding a particular image are now conveniently in closer proximity to the image.

Embodiments of the invention thus far have stored the data for the user preferences 210 within the client 100. Further embodiments may have the mechanism to control the rendering of the content stored on the server 102 instead of the client 100. The user-defined preferences 210 may instead be stored on the server 102. This alternative embodiment would also require that the processes as described in FIG. 3 be performed on the server 102.

Implicit in the discussion so far is that the plug-in 208 contains a priori information of the content source, the specific web address of the website which the content is drawn from. In one embodiment of the invention, the content source may not be known by the plug-in 208, but instead is obtained from a variety of sources utilizing independent software programs known as “agents.” Agents, as used herein are content retrieval programs which will automatically assemble content from differing sources based on criteria supplied by the user. As a result of the use of such agents a wide variety of unique content which has not been anticipated by the user can be retrieved and rendered by the browser 206, in accordance with user-defined settings.

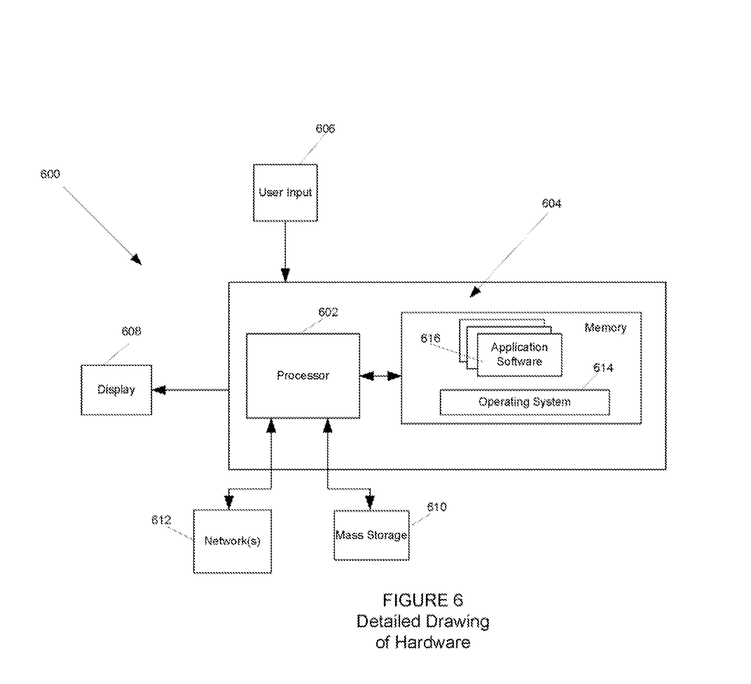

Referring to FIG. 6 of the drawings, reference numeral 600 generally indicates hardware that may be used to implement any of the systems 100 or 102 in accordance with one embodiment. The hardware 600 typically includes at least one processor 602 coupled to a memory 604. The processor 602 may represent one or more processors (e.g., microprocessors), and the memory 604 may represent random access memory (RAM) devices comprising a main storage of the hardware 600, as well as any supplemental levels of memory e.g., cache memories, non-volatile or back-up memories (e.g. programmable or flash memories), read-only memories, etc. In addition, the memory 604 may be considered to include memory storage physically located elsewhere in the hardware 600, e.g. any cache memory in the processor 602, as well as any storage capacity used as a virtual memory, e.g., as stored on a mass storage device 610.

The hardware 600 also typically receives a number of inputs and outputs for communicating information externally. For interface with a user or operator, the hardware 600 may include one or more user input devices 606 (e.g., a keyboard, a mouse, etc.) and a display 608 (e.g., a Cathode Ray Tube (CRT) monitor, a Liquid Crystal Display (LCD) panel).

For additional storage, the hardware 600 may also include one or more mass storage devices 610, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the hardware 600 may include an interface with one or more networks 602 (e.g., a local area network (LAN), a wide area network (WAN), a wireless network, and/or the Internet among others) to permit the communication of information with other computers coupled to the networks. It should be appreciated that the hardware 600 typically includes suitable analog and/or digital interfaces between the processor 602 and each of the components 604, 606, 608 and 612 as is well known in the art.

The hardware 600 operates under the control of an operating system 614, and executes various computer software applications, components, programs, objects, modules, etc. (e.g. a program or module which performs operations described above) to perform other operations described with reference to FIGS. 3 through 5. Moreover, various applications, components, programs, objects, etc. may also execute on one or more processors in another computer coupled to the hardware 600 via a network 612, e.g. in a distributed computing environment, whereby the processing required to implement the functions of a computer program may be allocated to multiple computers over a network.

In general, the routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

1. A method, comprising:
receiving user-defined settings to control the rendering of content by a browser;
receiving content from a web-server, the content defining a web-page;
receiving default settings from the web-server to control how the content is to be rendered by the browser; and
rendering the content in the browser in accordance with the user-defined settings.

2. The method of claim 1, wherein the default settings are defined by a web-developer.

3. The method of claim 1, wherein the user-defined settings comprises a content-hide setting to control whether a pre-defined content area of the web-page is rendered in the browser.

4. The method of claim 1, wherein the user-defined settings comprises a content-overlap setting to control overlapping of pre-defined content areas of the web-page when rendered in the browser.

5. The method of claim 1, wherein the user-defined settings comprises a background-override setting to control if a default background of the web-page is replaced with a custom background when rendered in the browser.

6. The method of claim 1, wherein the user-defined settings comprises a content-area-shape setting to control a shape of a pre-defined content area of the web-page when rendered in the browser.

7. The method of claim 1, wherein the user-defined settings comprises a content-mix setting to control a mixing of content for one pre-defined content area of the web-page with the content for another pre-defined area when rendered in the browser.

8. A client device, comprising:
a processing component; and
a memory coupled to the processing component, the memory storing instruction which when executed by the processing component causes the client device to perform a method comprising:
receiving user-defined settings to control the rendering of content by a browser;
receiving content from a web-server, the content defining a web-page;
receiving default settings from the web-server to control how the content is to be rendered by the browser; and
rendering the content in the browser in accordance with the user-defined settings.

9. The client device of claim 8, wherein the user-defined settings comprises a content-hide setting to control whether a pre-defined content area of the web-page is rendered in the browser.

10. The client device of claim 8, wherein the user-defined settings comprises a content-overlap setting to control overlapping of pre-defined content areas of the web-page when rendered in the browser.

11. The client device of claim 8 wherein the user-defined settings comprises a background-override setting to control if a default background of the web-page is replaced with a custom background when rendered in the browser.

12. The client device of claim 8, wherein the user-defined settings comprises a content-area-shape setting to control a shape of a pre-defined content area of the web-page when rendered in the browser.

13. The client device of claim 8, wherein the user-defined settings comprises a content-mix setting to control a mixing of content for one pre-defined content area of the web-page with the content for another pre-defined area when rendered in the browser.

14. A computer-readable medium having stored therein a sequence of instructions which when executed by a client device causes the client device to perform a method comprising:
receiving user-defined settings to control the rendering of content by a browser;
receiving content from a web-server the content defining a web-page;
receiving default settings from the web-server to control how the content is to be rendered by the browser; and
rendering the content in the browser in accordance with the user-defined settings.

15. The computer-readable medium of claim 14, wherein the user-defined settings comprises a content-hide setting to control whether a pre-defined content area of the web-page is rendered in the browser.

16. The computer-readable medium of claim 14, wherein the user-defined settings comprises a content-overlap setting to control overlapping of pre-defined content areas of the web-page when rendered in the browser.

17. The computer-readable medium of claim 14, wherein the user-defined settings comprises a background-override setting to control if a default background of the web-page is replaced with a custom background when rendered in the browser.

18. The computer-readable medium of claim 14, wherein the user-defined settings comprises a content-area-shape setting to control a shape of a pre-defined content area of the web-page when rendered in the browser.

19. The computer-readable medium of claim 14, wherein the user-defined settings comprises a content-mix setting to control a mixing of content for one pre-defined content area of the web-page with the content for another pre-defined area when rendered in the browser.

20. The computer-readable medium of claim 14, wherein the default settings are defined by a web-developer.
